(19) United States
(12) Patent Application Publication
(10) Pub. No.: US 2021/0016302 A1
(43) Pub. Date: Jan. 21, 2021

(54) SPHERICAL SHOWER HEAD

(71) Applicant: Marco Antonio GARCIA VILLAREAL, Monterrey (MX)

(72) Inventor: Marco Antonio GARCIA VILLAREAL, Monterrey (MX)

(21) Appl. No.: 17/040,754

(22) PCT Filed: Mar. 23, 2018
(86) PCT No.: PCT/MX2018/000032

§ 371 Date: Sep. 23, 2020

(51) Int. Cl. B05B 1/18

(52) U.S. Cl. CPC B05B 1/185

(57) ABSTRACT

The invention relates to a water-saving spherical shower head. Due to its operation, it only requires a minimal expenditure of 600 millilitres of water per minute, and is capable of vertically generating a soft, dense curtain of rain, produced by fine lines of water that form concentric parabolas with various ranges, generated by a novel system of micro-conduits arranged in various circumferences, oriented at various firing angles and executed perpendicularly on the surface of a hollow hemisphere. The head is characterised in that it produces a soft, dense curtain of rain, with a pressure of 60 cm of water. With an expenditure of 600 millilitres per minute, the curtain of rain covers a surface area of 154 cm2 at a distance of 5 cm, and opens up to a diameter of 14 cm. The shower head is inadequate for expenditures of more than 600 millilitres per minute.

### FIELD OF THE INVENTION

The technological sector with which the current invention is related, is that of the shower heads, which through the holes in their outlet cover, distribute the water in a plurality of water lines which are invariably located above the head and body of the user during shower.

### BACKGROUNDS OF THE INVENTION

Currently our planet is facing a dramatic and alarming shortage of freshwater; obtaining potable water for human use and distributing it to each person in society is a titanic and fundamental task of any government in the world, so now more than ever, it is very important to use water efficiently and rationally.

The problem and crisis of water scarcity, is a current and general problem world-wide, where mainly climate change and the irresponsible use of the vital liquid by human beings are leading human ingenuity to develop new inventions that help in solving this problem.

In order to contribute to the preservation of hydraulic resources in the world, regulations have been implemented aimed at the efficient use of water for human consumption, to allow the supply of the vital liquid to the world population to be maintained and increased.

One of the most important measures that have been implemented in these standards for the rational use of water has been the regulation of domestic consumption through the use of water-saving devices, also called low water consumption devices, as is the case of shower heads.

In the world market, there are different types of shower heads for body hygiene, which require high water consumption for their operation, so it has been necessary for many countries to regulate the expense they supply to avoid unnecessary waste when showering.

Figures recently provided by the WHO (World Health Organization) concerning water consumption when showering, establish an average expenditure of 200 liters in a 10-minute shower, the WHO recommends an average expenditure of 50 liters per 10 minutes (5 lts/min).

However, when there is a water crisis, the measures are usually more dramatic, for example; Cape Town, South Africa could be left without water due to the severe drought that began in 2014.

Today, the second city with most population in South Africa is facing a crisis due to the lack of this liquid, which, according to the local government, would have stopped reaching most residential areas and businesses on Apr. 16, 2018, when the dams reach a peak level of 13.5 percent, in what has been called the ‘day zero’.

If this limit is reached, the main tourist destination in that country would not only become the first large city in which water would stop flowing from the taps, but in less than three months it would also have military personnel in the streets to guard the 200 collection points projected to provide water to four million people,

A point of no return has been reached, for now, the strategy of the Government of Cape Town, South Africa, is to control water consumption through rationalization.

As measures to try to postpone “day zero” as long as possible, the Cape Town Government restricted daily water consumption to 50 liters per person. The pressure on the supply network also decreased and the installation of devices in the houses that measure expenditure began and, once the daily limit per household (350 liters) is exceeded, the service will be suspended.

First of all, it should be noted that despite of the advances and innovations related to the worldwide manufacture of shower heads or showers for bathrooms, not much changes have been seen in the design of the water outlet cover of these products, since the exit holes continue to guide the water lines directly to the user's body and the changes have only focused on the physical and aesthetic appearance of the product.

The main disadvantage of all known shower heads on the market is the fact that these shower heads, through the water outlet holes of their distributor caps, direct the water lines directly towards the body of the user. The fact of having the water lines always directed to the user gives freedom to open the taps to the maximum, with a consequent excessive expense and waste of water when showering, since it can be used up to 100% of the flow of water from the pipe, regardless of the water consumption, as occurs in the vast majority of non-saving shower heads, in which the water output consumption can be the same as discharge free of the pipe where these shower heads are connected.

The claimed invention, the spherical shower head, technically solves the aforementioned disadvantage, thanks to its original and novel spherical geometry, whose surfaces form a thick-walled hollow semi-sphere, where perpendicularly in different circumferences, a plurality of equidistant micro-ducts are located to each other, executed at different angles and not directed towards the user's body.

The above-described arrangement of the micro-ducts in the spherical shower head can produce a variety of water lines that will directly depend on the amount of water flowing into its outlet. An exaggerated flow will produce a not very dense rainfall and away from the user's body; gradually, reducing this water flow, smaller rainfall patterns will form in the shape of concentric parabolas of different sizes and different densities. The density and size of these parabolic rainfall patterns will be decided by the user and it will directly depend on the amount of outlet water that is regulated, so the user will be obligated to adjust the water consumption to the point where the parabolic rainfall is satisfying for showering.

For the current invention, the spherical shower head, the setting and the optimal operating range to obtain a dense, ergonomic and satisfactory parabolic rainfall for the user during the shower, will be, when it flows out of the spherical shower head a water consumption between 300 to 600 milliliters per minute.

It is noteworthy that the dense parabolic rain formed with water consumption in the range of 300 to 600 milliliters per minute produced by the spherical shower head, is considered optimal because 5 cm. is enough of a distance between the spherical shower head and the user's head so that all the water lines generated by the micro-ducts fall on it, covering all the area of the upper part of a user's head, this being 113.09 cm² corresponding to a diameter of 12 cm. with a flow of 300 milliliters per minute and a coverage area of 154 cm² corresponding to an average diameter of 14 cm. with a flow of 600 milliliters per minute.

As for the technical advantages that the current invention, spherical shower head, has in comparison to the already known shower heads, it is important to point out that this shower head, completely changes the traditional concept of shower heads, which invariably direct the water lines towards the user's body. Unlike the traditional shower heads, and as absurd as it might seem, the shower head that this invention claims, with all intention, does not direct the water lines towards the user's body when he/she opens the taps that control the water output and exceeds the flow of 600 milliliters per minute; and it does direct the water lines towards the user only when he/she slightly opens the taps that control the output of the water from the shower head. In other words, this spherical shower head produces a gentle parabolic rainfall and it is ultra-saver, and it only works correctly and directs the water lines to the user's body, when the water flow is extremely reduced between 300 to 600 milliliters per minute, this extreme reduction allowing that the force of gravity can act on the water lines to create concentrical parabolic rainfall patterns of different sizes that together produce an ultimate rainfall, which density and coverage area can be variable and its size can be precisely adjusted, increasing or decreasing the water flow.

Therefore, it is intended to protect this spherical shower head by means of the current application since it is a shower head that provides an optimal consumption that is preferably in a range between 300 to 600 milliliters per minute, given by the relation of the water flow and the density of the water lines that falls into the surface of the user's head, which's rainfall diameter is 12 to 14 centimeters corresponding to 113.09 cm² to 154 cm², which is why this spherical shower head really provides an effective solution in terms of a truly incredible water saving when showering.

The characteristical details of this spherical shower head are clearly shown in the following description and annexed figures.

### BRIEF DESCRIPTION OF THE FIGURES

FIG. 1 is an isometric view of the spherical shower head.

FIG. 2 is a bottom view of the spherical shower head.

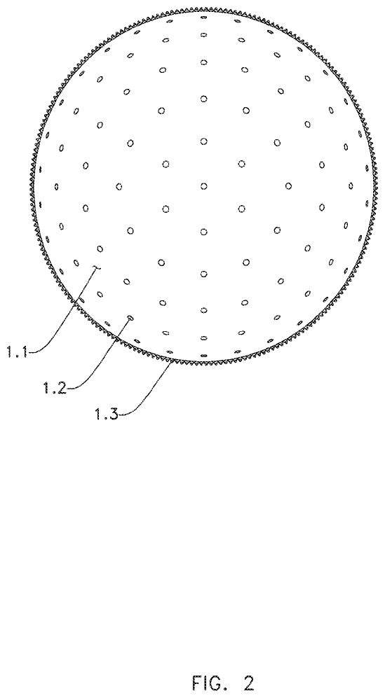

FIG. 3 is an upper view of the spherical shower head connected to a tube.

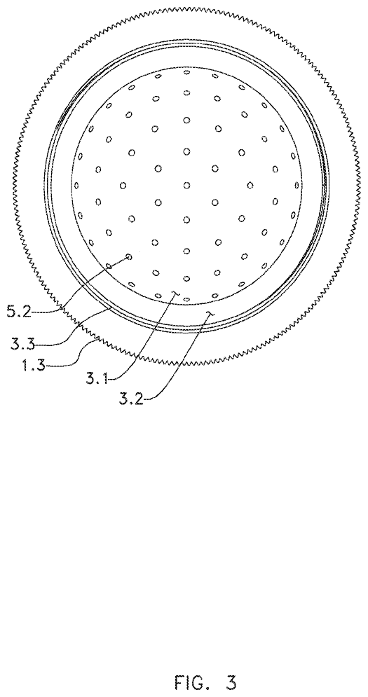

FIG. 4 is a front view showing a vertical cut line of the spherical shower head.

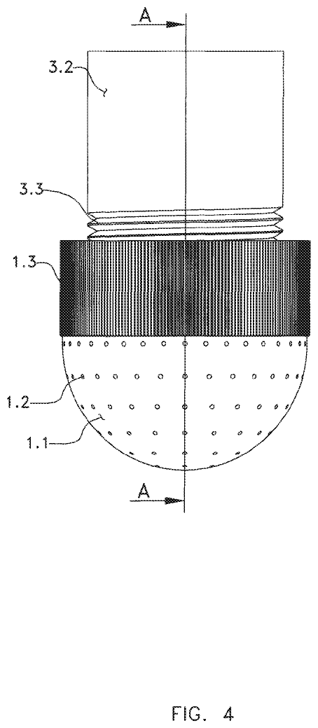

FIG. 5 is a front view showing the spherical shower head in cross section A-A.

FIG. 6 is a front view showing a horizontal section line of the spherical shower head.

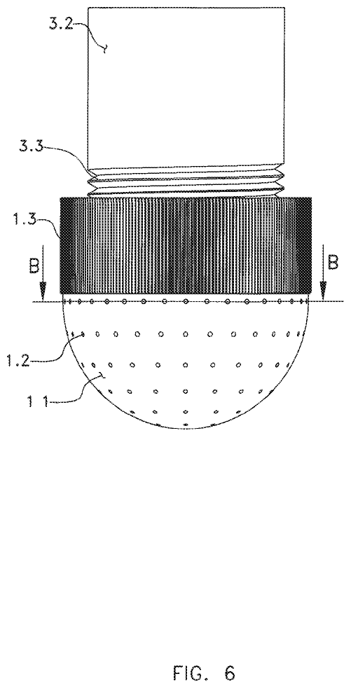

FIG. 7 is an upper view showing the spherical shower head in horizontal section B-B.

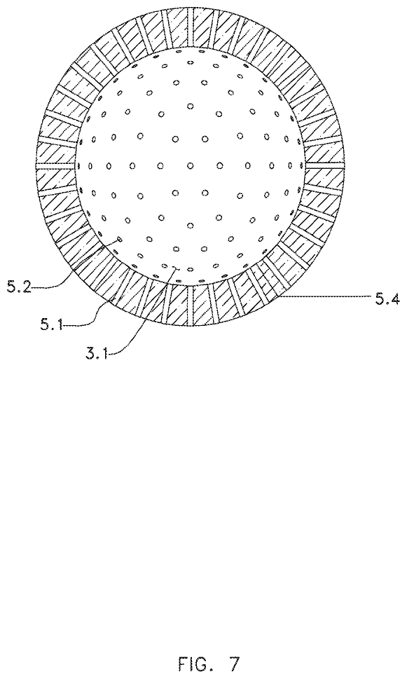

FIG. 8 is an isometric view of the spherical shower head connected to a water supply tube.

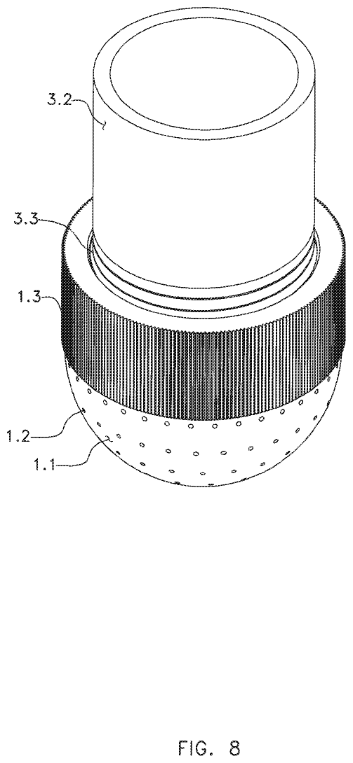

FIG. 9 is a schematic side view of a spherical shower head, installed in a shower room with a user, in a special embodiment, showing its operation with a small water container.

FIG. 10 is a schematic side view of the spherical shower head, installed in a shower room with a user, to show the water stream that is produced when the water flow tends to 0 liters per minute.

FIG. 11 is a schematic upper view of the spherical shower head, installed in a shower room with a user, to show the water stream that is produced when the water flow tends to 0 liters per minute.

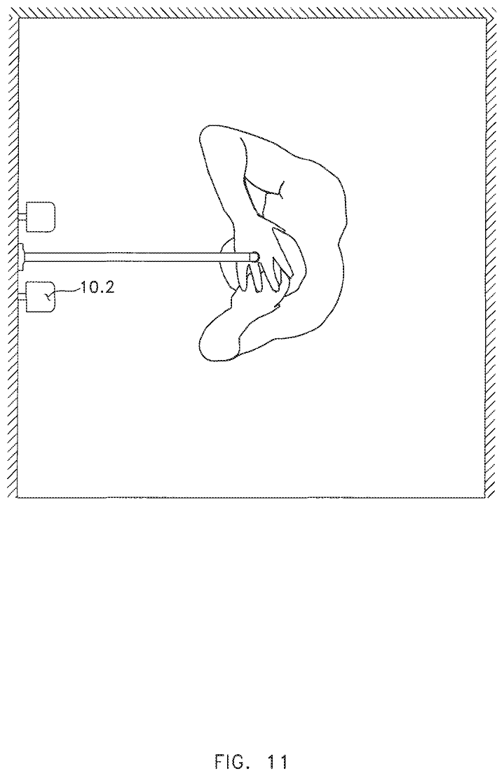

FIG. 12 is a schematic side view of the spherical shower head, installed in a shower room with a user, that shows the rainfall produced when the water consumption is 300 milliliters per minute, portraying the rainfall section formed by different sized parabolas, opening at a diameter of 12 cm. having a distance of 5 cm. between the user's head and the spherical shower head.

FIG. 13 is a schematic upper view of the spherical shower head, installed in a shower room with a user, that shows the rainfall produced when the water consumption is 300 milliliters per minute, opening at a diameter of 12 cm, covering an area of 113.09 cm².

FIG. 14 is a full-scale front schematic view of the spherical shower head, a user and a section of a parabolic rainfall produced when the water consumption is 600 milliliters per minute, opening at a diameter of 14 cm., having a distance of 5 cm. between the user's head and the spherical shower head.

FIG. 15 is a schematic upper view of the spherical shower head, installed in a shower room with a user, to show the rainfall produced when the water consumption is 600 milliliters per minute, opening at a diameter of 14 cm., covering an area of 154 cm².

FIG. 16 is a schematic side view of the spherical shower head, installed in a shower room with a user, to show the dispersion of the parabolic rainfall produced when the water consumption is 900 milliliters per minute, portraying there the rainfall section formed by different sized parabolas opening at a diameter of 50 cm., having a distance of 5 cm. between the user's head and the spherical shower head.

FIG. 17 is a schematic upper view of the spherical shower head, installed in a shower room with a user, showing the rainfall produced when the water consumption is 900 milliliters per minute, opening at a diameter of 50 cm., covering an area of 1,963.5 cm².

FIG. 18 is a schematic side view of the spherical shower head, installed in a shower room with a user, showing the dispersion of the parabolic rainfall produced when the water consumption is 3,000 milliliters per minute, portraying there the rainfall section formed by different sized parabolas, opening at a diameter of 1 meter, having a distance of 5 cm. between the user's head and the spherical shower head.

FIG. 19 is a schematic upper view of the spherical shower head, installed in a shower room with a user, showing the rainfall produced when the water consumption is 3,000 milliliters per minute, opening at a diameter of 1 meter, covering an area of 7,854 cm².

FIG. 20 is a schematic side view of the spherical shower head, installed in a shower room with a user, showing the dispersion of the parabolic rainfall produced when the water consumption is 5,600 milliliters per minute, portraying there the rainfall section formed by different sized parabolas opening at a diameter of 3 meters, having a distance of 5 cm. between the user's head and the spherical shower head.

FIG. 21 is a schematic upper view of the spherical shower head, installed in a shower room with a user, showing the rainfall produced when the water consumption is 5,600 milliliters per minute, opening at a diameter of 3 meters, covering an area of 70,686 cm².

FIG. 22 is a schematic side view of the spherical shower head, installed in a shower room with a user with a shorter height, showing the rainfall produced when the distance from the shower head to the user's head is greater than 5 cm., which requires to reduce the water flow even more to be able to cover the surface of 154 cm², corresponding to a 14 cm. diameter.

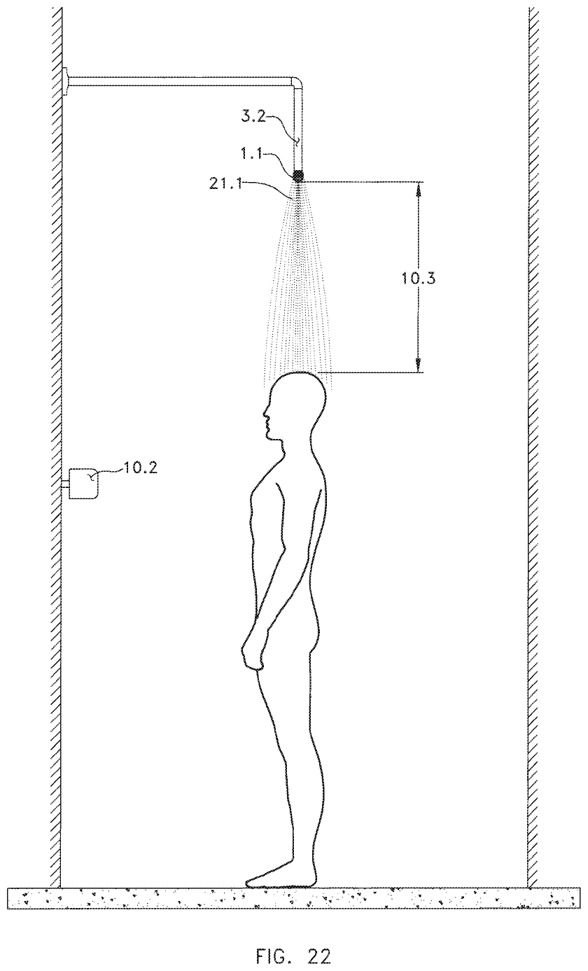

### DETAILED DESCRIPTION OF THE INVENTION

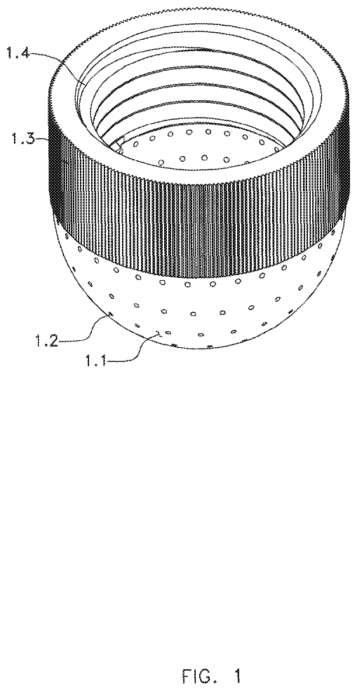

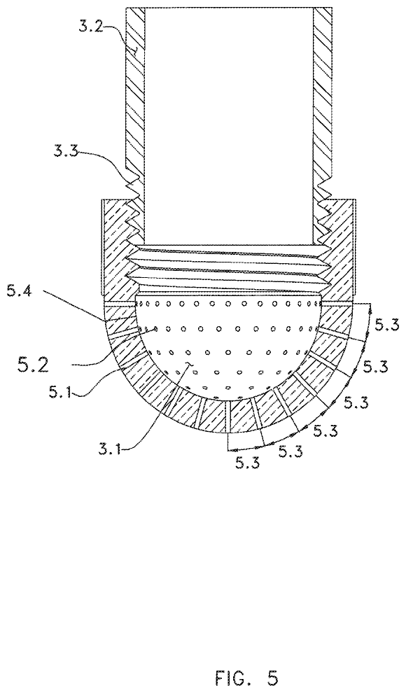

The current invention refers to a spherical shower head that can generate a soft parabolic rainfall and adding up to that is ultra-saving, preferably made of metallic material under the machining, drilling and knurling process, and can be made of any other material such as plastic, which comprises in (FIG. 1) a semi-sphere body (1.1) with an extension of material that forms a knurling (1.3), which is hollow inside (FIG. 5). This spherical body (FIG. 1) containing a plurality of micro-ducts (1.2) with a diameter in a range of 254 to 635 microns, for this preferred embodiment, angularly equidistant from each other, oriented and made in various horizontal circumferences and preferably separated by 15° (5.3) perpendicular to its outer spherical surface (1.1), which as a whole at the water outlet will form a dense and soft parabolic rainfall (12.1 and 14.1) to cover the user's body; this semi-sphere (1.1) incorporates inside a female thread (1.4) that receives the thread (3.3) of the water supply tube (3.2), which can be of different lengths (3.2).

The inner spherical surface (3.1) and the outer spherical surface (1.1) form a thick wall (5.4) 3 to 6 times the diameter of the micro-ducts (5.1) which are directed as seen in (FIG. 5) angularly equidistant (5.3) and perpendicular to the outer surface of the semi-sphere (1.1); the water enters through the holes (5.2), is led through the micro-ducts (5.1) and exits through the holes (1.2). When exiting through these micro-ducts (5.1) they will form a set of different sized parabolas (12.1, 14.1, 16.1, 18.1, 20.1 and 22.1). The size of the parabola will depend on the amount of water used.

The micro-ducts (5.1) angularly equidistant from each other, oriented and made in different horizontal circumferences and separated every 15° (5.3) are for this preferred embodiment. Being able to be placed at different degrees, every 5°, every 10° or even another angle (5.3), it can even lack of a horizontal line of micro-ducts (5.1).

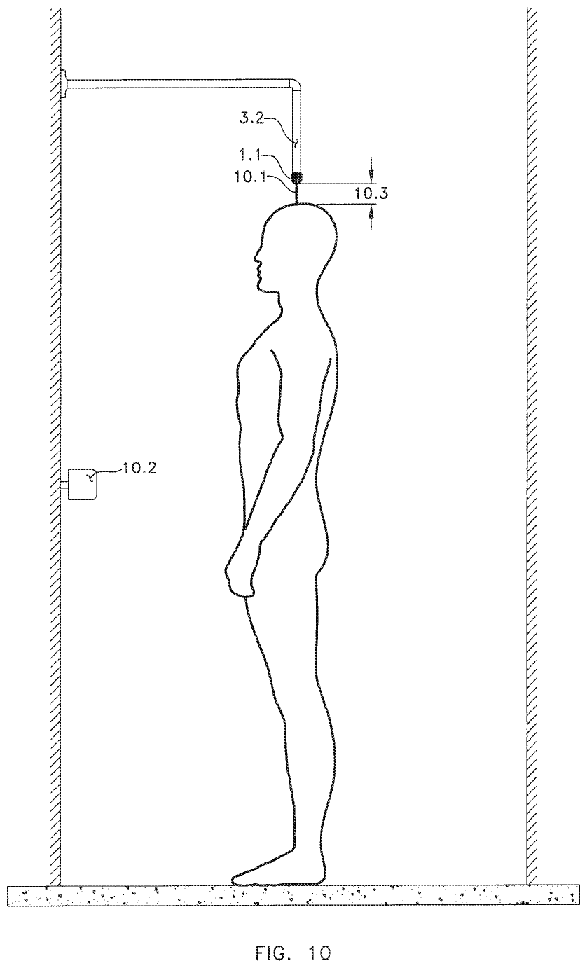

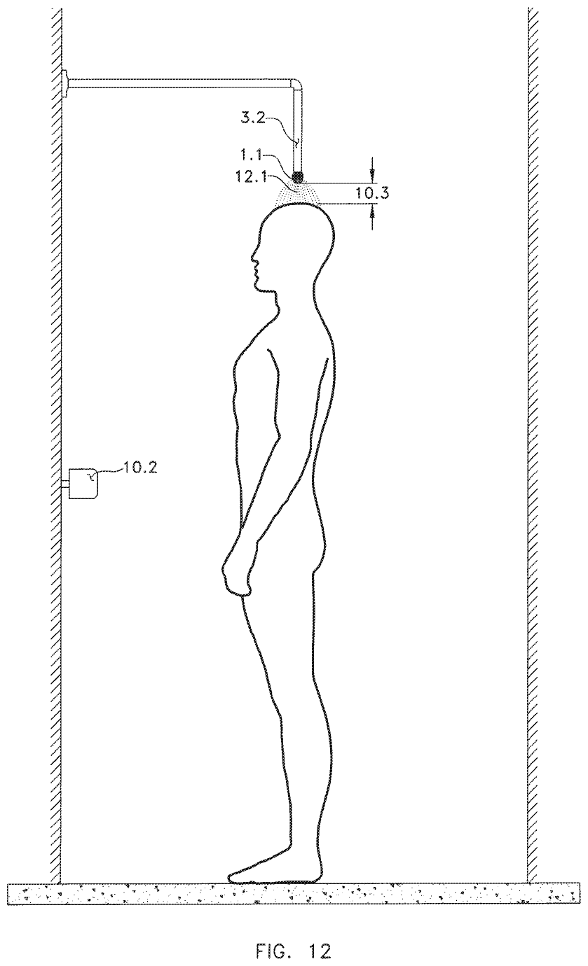

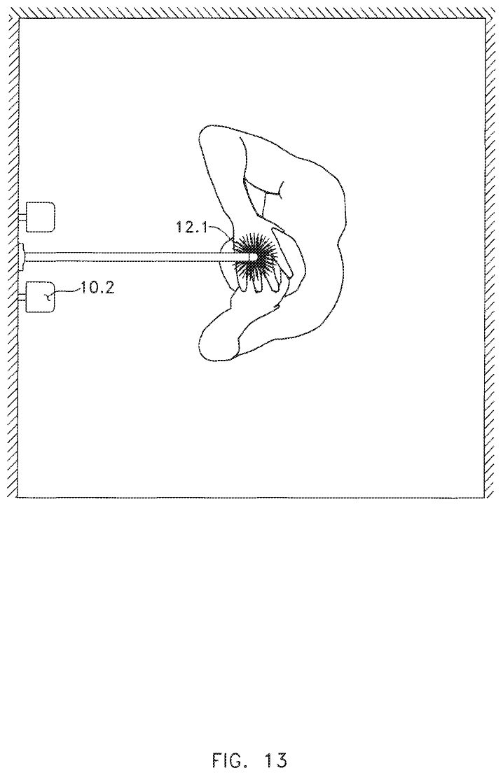

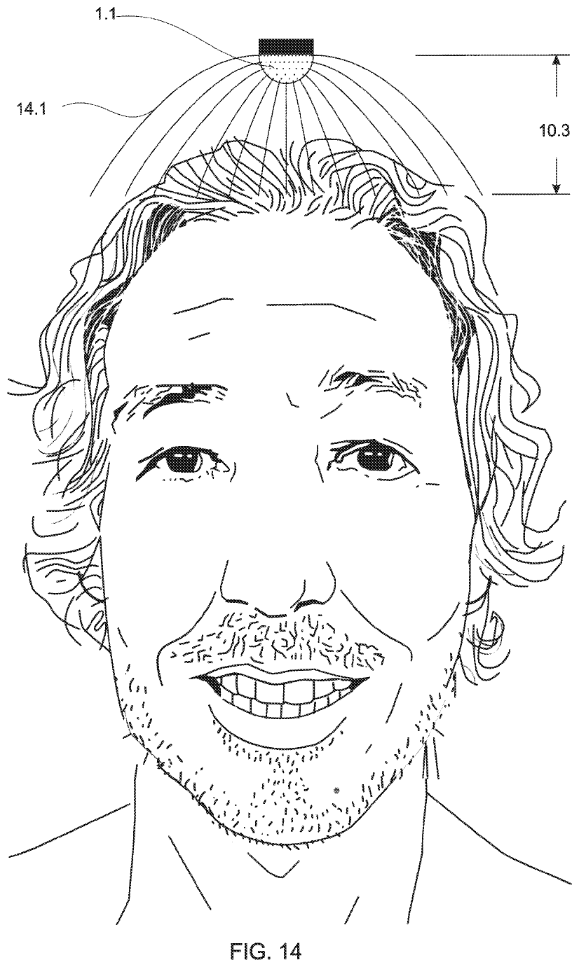

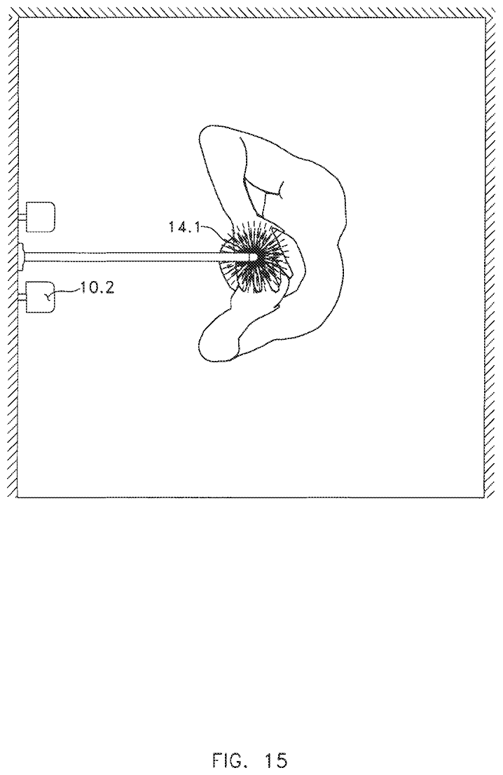

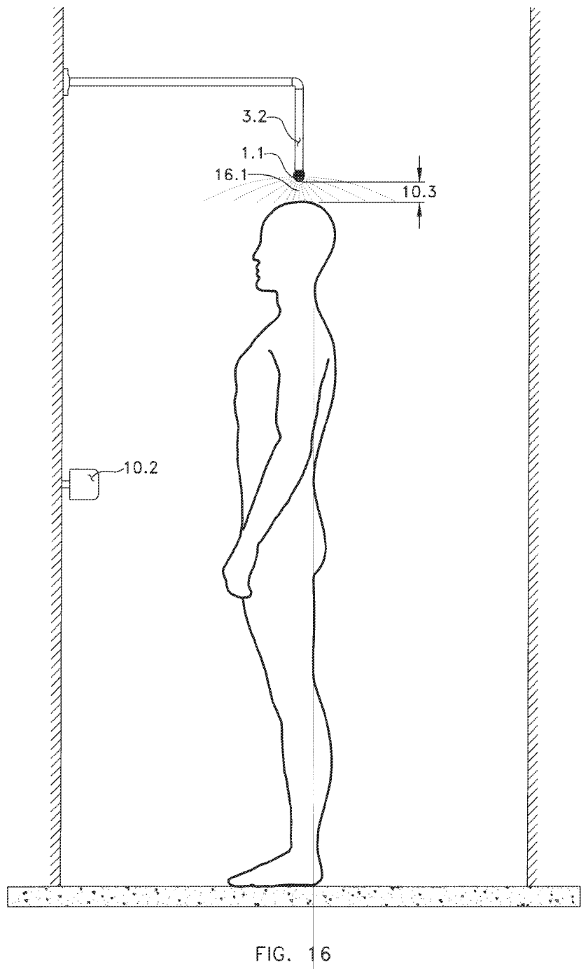

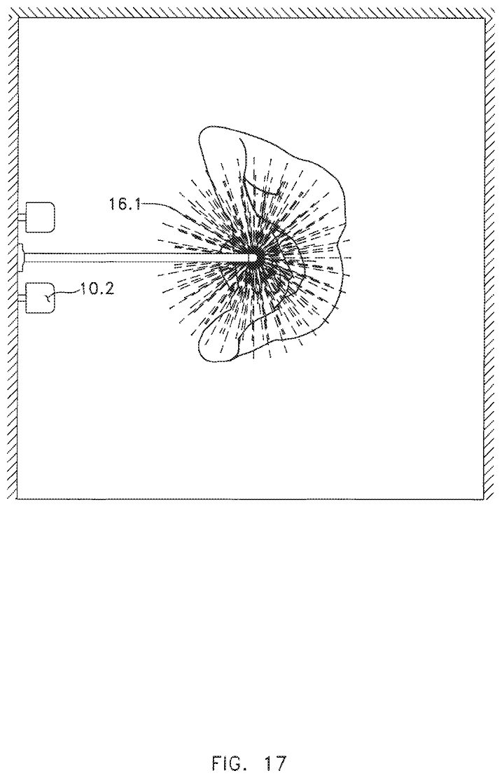

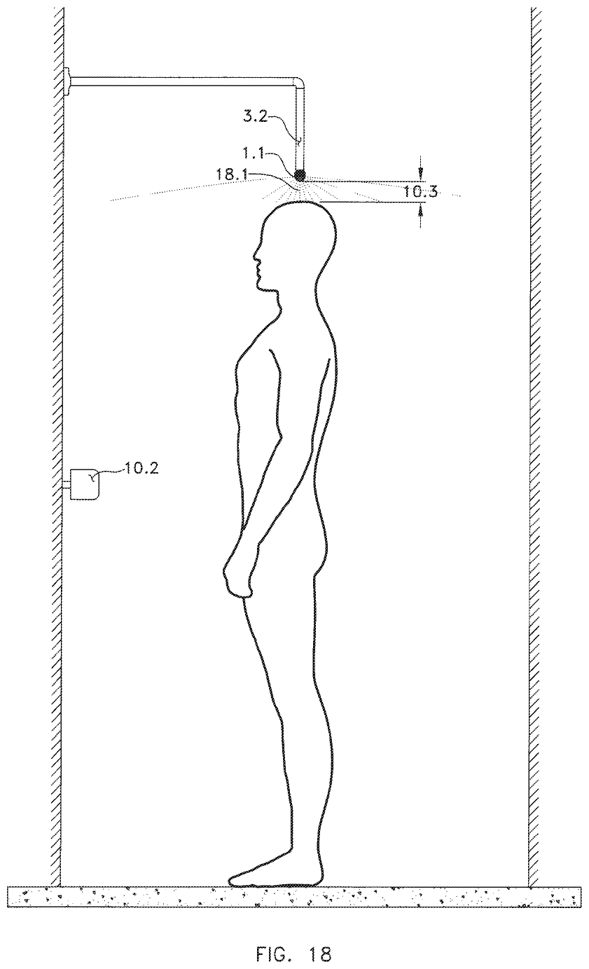

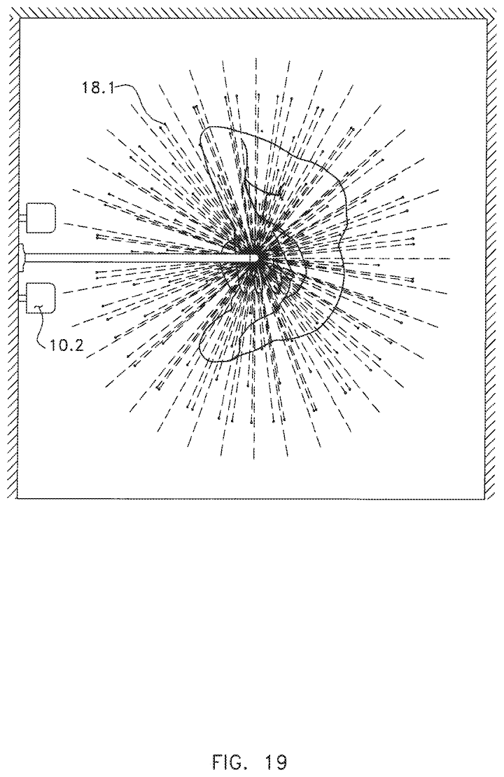

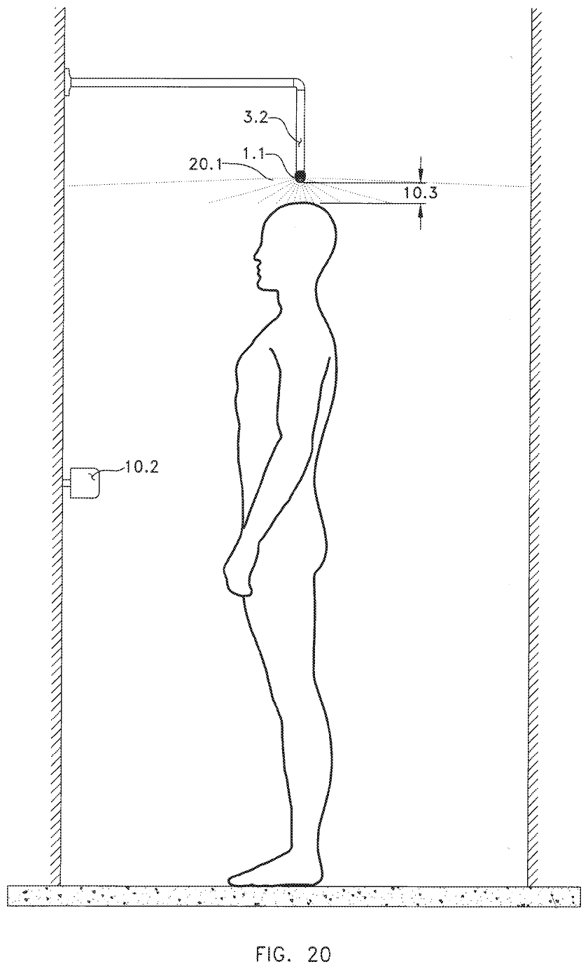

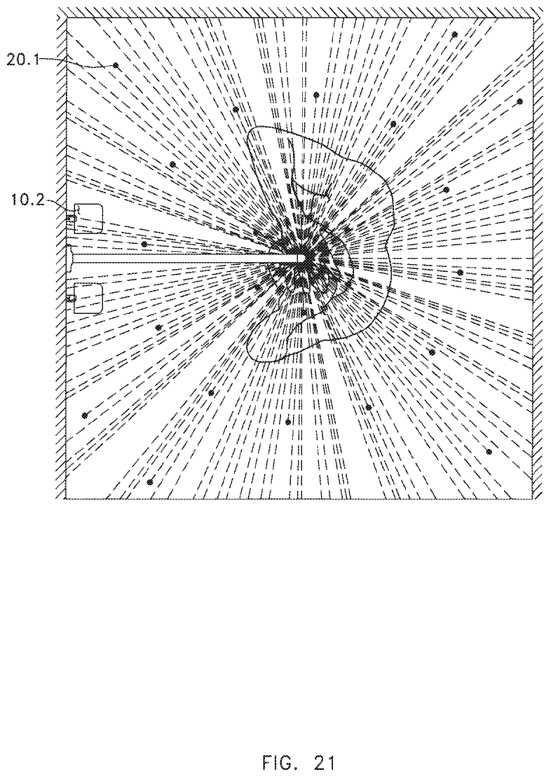

According to (FIG. 10), the spherical shower head shows the water stream (10.1) when the water consumption is reduced to rates lower than 300 milliliters per minute, which would be when the water lines just start flowing. This shower head forms a soft parabolic rainfall (12.1) as shown in (FIG. 12) and that forms a diameter of 12 cm. in the user's head, placed 5 cm. from it, when the water consumption is 300 milliliters per minute, it is shown in (FIG. 13) the rainfall coverage (12.1) in the user's head, covering an area of 113.09 cm². In (FIG. 14) the optimal rainfall is shown achieved with a water consumption of 600 milliliters per minute, opening at a diameter of 14 cm., having a distance (10.3) of 5 cm. between the user's head and the spherical shower head (1.1), this coverage (14.1) shown in (FIG. 15) covering an area of 154 cm². As the user increases the water consumption above the 600 milliliters per minute, the parabolic rainfall (16.1) opens so that only the water lines of 0°, 15° and 30° are the ones that fall on the user's head, as shown in (FIG. 16), the parabolic rainfall tends to disperse away from the user; having a diameter of the rainfall of 50 cm., when the user's head is 5 cm. away from the shower head (10.3). In this case, the rest of the water, as it does not touch the user, is a total waste, as shown in (FIG. 17) with a coverage of 1,963.5 cm². When the supply valve (10,2) is opened even more, increasing the water flow to 3,000 milliliters per minute, the largest water line of the parabolic rainfall is dispersed (18.1) to 1 meter of diameter with the shower head placed 5 cm. away from the user's head, the water barely touches the user (FIG. 18) since most of the water coming out of the spherical shower head does not touch the user (FIG. 19), with a coverage area of 7,854 cm². Given the case that the user increases the water consumption to 5,600 milliliters per minute, the dispersion of the largest water line of the rainfall (20.1) is such that it would be forming a 3 meters diameter with the shower head 5 cm. away from the user's head, as shown in (FIG. 20), with a coverage area of 70,686 cm², as shown in (FIG. 21). Given the case that the user's head is not 5 cm. away from the spherical shower head, the size of the supply tube (3.2) can be adjusted. Given the case of they supplying tube not being adjusted, the distance (10.3) between the user's head and the shower head would be variable, therefore, the setting of the rainfall (21.1) would be saving more water due to the decrease of consumption of water to adjust the rainfall to cover the user's body.

In a preferred embodiment of the invention, the spherical shower head has a size of 25 mm. of diameter on the semi-sphere with a built-in knurling, a series of radially equidistant micro-duct lines, executed at angles of 15° of separation and a internal thread corresponding to the supplying tube.

In another preferred embodiment of the invention, the spherical shower head can have the micro-ducts with a separation at different degrees every 5° or every 10° or as desired.

In another preferred embodiment of the invention, the spherical shower head can have another dimension in the diameter of the semi-sphere, in this case, 16 mm.

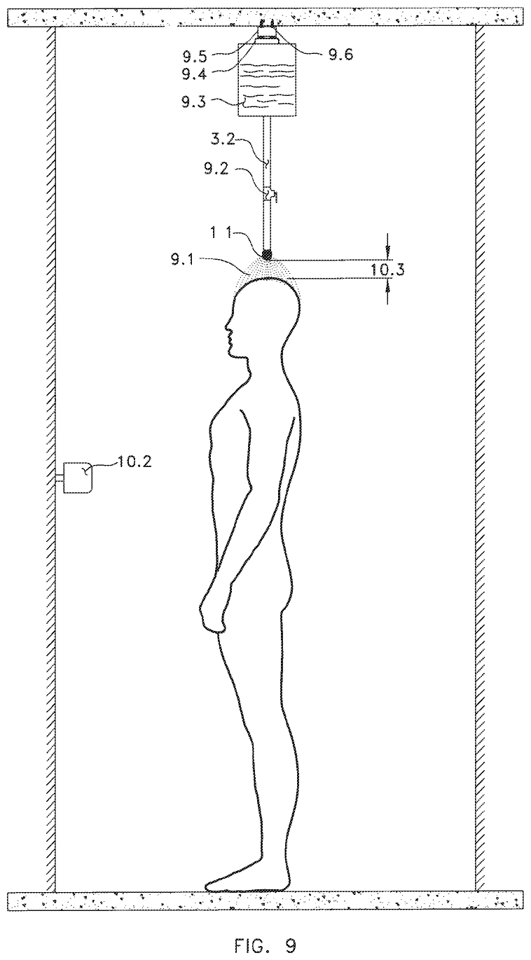

In a specially preferred embodiment and to show the ability to operate at a very low pressure of only 60 cm. of water column, the current spherical shower head (1.1), in (FIG. 9) a user has placed a container (9.3) of approximately 4 liters of water, which has a handle (9.4) corresponding with the holder (9.5) forming a “U” shape fixated to the ceiling of the shower room with a pair of screws (9.6). To this container it is incorporated a tube (3.2) with a valve (9.2) in such a way that by the only effect of the force of gravity the spherical shower head generates a very satisfying rainfall (9.1) of 14 cm. in diameter of 5 cm. from the user's head. Therefore, the user must be able to take a shower with only the usage of a 4-liter water container, saving a lot of water, according to the tests carried out using this especially preferred embodiment, The spherical shower head is capable of generating a rainfall that can be used in all circumstances, even with a bag, in the most austere conditions.

The scientific and mechanical foundation of the generation of the parabolic rainfall produced by the current spherical shower head invention is supported by the laws of physics and mathematical discoveries and their formulas that are described below.

As it is well known, when we launch a body with a certain velocity, either horizontally or at an angle to the horizontal, it describes a parabolic trajectory and can be considered as the composition of two simultaneous and independent movements, one horizontal and uniform on the X axis and the other vertically and uniformly accelerated on the Y axis, produced by the force of gravity “g” 980 cm/sec² as demonstrated by the scientist Galileo Galllei in his work Dialogue on the Systems of the World of 1633.

In this case we have selected the exit point as the origin of coordinates, if the exit velocity is v₀ and the angle is α, we will have that the components of the initial velocity are:

v₀ₓ=v₀·cos α

v_{0y}=v₀·senα

And the kinematic properties of the body at any instant (t) of its motion are:

| Magnitude | Component x | Component y |
|---|---|---|
| acceleration | aₓ = 0 | a_{y} = −g |
| speed | vₓ = v₀ₓ | v_{y} = v_{0y} − gt |
| position | x = v₀ₓt | y = v_{0y}t − 1/2gt² |

The acceleration does not depend on time (it is constant), but the velocity and position of the body do depend on the time; in parabolic shooting, the height or maximum descent and the reach are of interest (or horizontal displacement achieved).

The maximum height is reached when the vertical component v_{y} of the velocity becomes zero; as v_{y}=v_{0y}−gt, the maximum height will be reached when t=v_{0y}/g. Using these data, it will be concluded that the value of the maximum height is:

yₘₐₓ=v²_{0y}/2g=v²₀/2gsen²α

The body will be advancing horizontally at a constant velocity v₀ₓ during the flight time, which will be 2t, since the body takes the same time to go up as to go down, therefore the reach is:

xₘₐₓ=v₀ₓ2t

In other words:

scope=xₘₐₓ=v²₀/gsen²α

Definitely, the invention of this innovative spherical shower head solves the problem of excessive water waste when the user takes a shower; as well as, it solves the problem of the deficient service offered to users by all known shower heads, when there are reduced water pressures and flows. Therefore, this spherical shower head satisfies the necessity of saving water, making it lasts at its most when taking a shower.

### SUMMARY OF THE INVENTION

This spherical shower head is an ultra-saving shower head, due to its optimal ergonomic operation, it only demands a minimum water consumption of 600 milliliters per minute, being able to vertically generate a soft and dense rainfall, produced by fine water lines that form concentric parabolas of different scopes, originated by a novel system of micro-ducts located in different circumferences, oriented at different firing angles and executed perpendicularly on a hollow semi-sphere surface, adding to that the following peculiarities:
1) To produce the soft and dense rainfall referred, it only requires a very low pressure water column of 60 cm.
2) With a water consumption of 600 milliliters per minute, having a 5 cm. distance between the spherical shower head and the user's head, the rainfall covers a surface of 154 cm² and opens to a diameter of 14 cm.
3) The spherical shower head's operation would be inadequate and awful if any user attempted to shower with a water consumption greater than 600 milliliters per minute.

1. Spherical shower head which incorporates an external knurling and an internal thread for coupling to the thread of a pipe that supplies water, essentially characterized by comprising micro-ducts executed perpendicularly on the surface of the hollow semi-sphere in concentric circumferences, which are arranged in a range between 0° and −90°; taking as reference for 0°, the horizontal axis of the shower head, which is located at the height of the largest diameter of the semi-sphere, and for −90°, the vertical axis itself. Allowing the formation of uniform water lines with parabolic trajectory, which as well originates concentric curtains of parabolic rainfall of different sizes, which together generate a parabolic rainfall.
